(19) United States
(12) Patent Application Publication
(10) Pub. No.: US 2012/0083218 A1
(43) Pub. Date: Apr. 5, 2012

(54) SYSTEM AND METHOD FOR COLLABORATIVE SPECTRUM ANALYSIS

(76) Inventors: Hrishikesh Gossain, Heathrow, FL (US); Peter Stanforth, Winter Springs, FL (US)

(21) Appl. No.: 12/894,548

(22) Filed: Sep. 30, 2010

(51) Int. Cl. H04B 17/00

(52) U.S. Cl. 455/67.11

(57) ABSTRACT

In systems and methods for analyzing spectrum, a radio system may sample spectrum and transmit the sample to a remote spectrum analysis system. The remote spectrum analysis system analyzes the sample to determine if an incumbent radio system or radar is present and returns analysis results to the radio system. The remote spectrum analysis system may use information acquired from other sources, such as a knowledge base of devices that operate in the vicinity of the radio system to assist in analyzing the spectrum sample.

### TECHNICAL FIELD OF THE INVENTION

The technology of the present disclosure relates generally to radio communications and, more particularly, to a system and method for collaborative spectrum analysis that includes offloading spectrum analysis from a radio system to a remote spectrum analysis system.

### BACKGROUND

Wireless radio communications are becoming increasingly popular. As a result, interference free spectrum to conduct wireless communications is often difficult to obtain, especially in unlicensed bands. To protect incumbent users of wireless spectrum, regulations have been imposed to require certain radio devices to sense spectrum use prior to operation to determine if a channel is free for use or occupied by an incumbent radio system. Exemplary bands for which regulations call for spectrum sensing include television (TV) whitespaces and channels at 5 GHz that are available for unlicensed use.

TV whitespace is made up of the guard bands and unused TV channels between channel 2 and channel 51 (corresponding to 54 MHz to 698 MHz). To avoid interference with digital TV broadcasts and other incumbent systems, such as wireless microphone systems, current regulations in the U.S. require that radios that use the TV whitespace to register and receive a channel map of available channels that may be used for the communications activity of the radio system. Current regulations require these radio systems to register every twenty-four hours. Also, for mobile radios, if the radio moves into a new location, a new registration is required. Also, TV whitespace radios (also referred to as TV whitespace band radios or TVBDs) may be required to detect incumbent use of a TV whitespace channel. Under some regulations, TVBDs may be required to detect incumbent signals as low as −114 dBm. As will be appreciated, detection of signals this small often is not an easy task.

DFS is a mechanism to allow unlicensed radio devices to use 5.4 GHz frequency bands that are already allocated to radar systems without causing interference to the incumbent radar systems. The concept behind DFS is to have the unlicensed radio device detect the presence of a radar system. If a radar signal is detected, the radio system vacates the channel and selects an alternate channel. Historically there were only four or five radar patterns that required detection. Recently, however, the patterns associated with radar signals have become very complex and many new patterns have been and continue to be introduced. In addition, network traffic on adjacent channels can be interpreted as a radar pattern, thereby resulting in frequent false positive detections. Therefore, the spectrum analysis that must be made by DFS radios is challenging and subject to change.

### SUMMARY

To improve spectrum analysis for the detection of incumbent radio systems and radar systems, the present disclosure describes systems and methods for analyzing spectrum. A radio system may sample spectrum and transmit the sample to a remote spectrum analysis system. The remote spectrum analysis system analyzes the sample to determine if an incumbent radio system or radar is present and returns analysis results to the radio system. The remote spectrum analysis system may use information acquired from other sources as a knowledge base of devices that operate in the vicinity of the radio system to assist in analyzing the spectrum sample and minimize false positive results.

According to one aspect of the disclosure, a radio system that identifies incumbent use of a wireless communication channel includes a radio circuit assembly; and a control circuit configured to: control the radio circuit to collect a representation of spectrum for the channel; output the representation of the spectrum to a remotely located spectrum analysis system that is configured to analyze the representation of the spectrum for presence of an incumbent user; and determine from a reply from the spectrum analysis system that indicates presence or absence of the incumbent user on the channel whether the channel is available for use by the radio system to conduct wireless communications.

According to one embodiment of the radio system, the representation of the spectrum includes I and Q samples.

According to one embodiment of the radio system, the radio system also outputs spectrum capture parameters that were used during collection of the I and Q samples for the representation of the spectrum to the spectrum analysis system.

According to one embodiment of the radio system, the spectrum capture parameters include one or more of duration of capture, timing information, channel information, capture resolution, capture bandwidth, or radio system location.

According to one embodiment of the radio system, the analysis by the spectrum analysis system includes ascertaining signal level of spectrum use by the incumbent user.

According to one embodiment of the radio system, the analysis by the spectrum analysis system includes ascertaining signal levels as low as −114 dBm.

According to one embodiment of the radio system, the representation of the spectrum includes pulse signal information.

According to one embodiment of the radio system, the pulse signal information includes pulse time information, pulse width information, and signal strength information.

According to one embodiment of the radio system, the radio system also outputs radio system location during collection of the pulse signal information for the representation of the spectrum to the spectrum analysis system.

According to one embodiment of the radio system, the analysis by the spectrum analysis system includes matching pulse signal information to a known radar signal pattern from a plurality of known radar signal patterns.

According to one embodiment of the radio system, detection of a radar signal pattern with the radio system triggers the collection and output of the representation of the spectrum for confirmation by the spectrum analysis system that a radar system is operating in a location of the radio system.

According to one embodiment of the radio system, the collection and output are triggered by receipt of a request from the spectrum analysis system.

According to one embodiment of the radio system, spectrum capture parameters that are used during the collection are specified by the spectrum analysis system.

According to another aspect of the disclosure, a method of identifying incumbent use of a wireless communication channel includes collecting a representation of spectrum for the channel with a radio system; transmitting the representation of the spectrum to a remotely located spectrum analysis system that is configured to analyze the representation of the spectrum for presence of an incumbent user; receiving a reply from the spectrum analysis system that indicates presence or absence of the incumbent user on the channel; and determining from the reply whether the channel is available for use by the radio system to conduct wireless communications.

According to one embodiment of the method, the representation of the spectrum includes I and Q samples.

According to one embodiment of the method, the radio system also transmits spectrum capture parameters that were used during collection of the I and Q samples for the representation of the spectrum to the spectrum analysis system, wherein the spectrum capture parameters include one or more of duration of capture, timing information, channel information, capture resolution, capture bandwidth, or radio system location.

According to one embodiment of the method, the analysis by the spectrum analysis system includes ascertaining signal level of spectrum use by the incumbent user.

According to one embodiment of the method, the analysis by the spectrum analysis system includes ascertaining signal levels as low as −114 dBm.

According to one embodiment of the method, the representation of the spectrum includes pulse signal information, including pulse time information, pulse width information, and signal strength information.

According to one embodiment of the method, the radio system also transmits radio system location during collection of the pulse signal information for the representation of the spectrum to the spectrum analysis system.

According to one embodiment of the method, the analysis by the spectrum analysis system includes matching pulse signal information to a known radar signal pattern from a plurality of known radar signal patterns.

According to one embodiment of the method, detection of a radar signal pattern with the radio system triggers the collection and output of the representation of the spectrum for confirmation by the spectrum analysis system that a radar system is operating in a location of the radio system.

According to yet another aspect of the disclosure, a method of spectrum analysis to identify incumbent use of a wireless communication channel for a remotely located radio system includes receiving a representation of spectrum for the channel from the radio system; analyzing the representation of the spectrum for presence of an incumbent user; and transmitting a reply to the radio system that indicates presence or absence of the incumbent user on the channel.

According to one embodiment of the method, the representation of the spectrum includes I and Q samples.

According to one embodiment of the method, the receiving also includes receiving spectrum capture parameters that were used during collection of the I and Q samples for the representation of the spectrum.

According to one embodiment of the method, the spectrum capture parameters include one or more of duration of capture, timing information, channel information, capture resolution, capture bandwidth, or radio system location.

According to one embodiment of the method, the analyzing includes ascertaining signal level of spectrum use by the incumbent user.

According to one embodiment of the method, the analyzing includes ascertaining signal levels as low as −114 dBm.

According to one embodiment of the method, the representation of the spectrum includes pulse signal information.

According to one embodiment of the method, the pulse signal information includes pulse time information, pulse width information, and signal strength information.

According to one embodiment of the method, the receiving also includes receiving radio system location during collection of the pulse signal information for the representation of the spectrum.

According to one embodiment of the method, the analyzing includes matching pulse signal information to a known radar signal pattern from a plurality of known radar signal patterns.

According to one embodiment of the method, detection of a radar signal pattern with the radio system triggers the radio system to transmit the representation of the spectrum for carrying out of the analyzing to confirm that a radar system is operating in a location of the radio system.

According to one embodiment, the method further includes transmitting a request to the radio system to trigger the radio system to transmit the representation of the spectrum.

According to one embodiment of the method, the request includes spectrum capture parameters that are used by the radio system for collection of spectrum information for the representation of the spectrum.

According to one embodiment of the method, the analyzing includes using information regarding known operation of incumbent users to generate the reply.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

### BRIEF DESCRIPTION OF THE DRAWINGS

FIG. 1 is a schematic view of a communication system that includes a radio system and a remote spectrum analysis system;

FIG. 2 is a flow chart representing a first exemplary set of cooperative actions taken by the radio system and the remote spectrum analysis system to conduct spectrum analysis for the detection of an incumbent user; and

FIG. 3 is a flow chart representing a second exemplary set of cooperative actions taken by the radio system and the remote spectrum analysis system to conduct spectrum analysis for the detection of an incumbent user.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

In the present document, embodiments are described primarily in the context of a radio system. The radio system may be a portable wireless radio communications device, such a mobile electronic device in the form of a mobile telephone. In other embodiments, the radio system may be a radio communication device that has a fixed location, such as a wireless access point for user terminals. In still other embodiments, the radio system may include plural radio devices that may form a network. Therefore, the spectrum analysis techniques described in this document may be applied to any type of appropriate electronic device and/or collection of electronic devices that engage in wireless communications. Also, the techniques may be used regardless of the communications protocol employed by the radio system or the purpose for the wireless communications (e.g., calls, data transmissions, Internet connectivity, etc.).

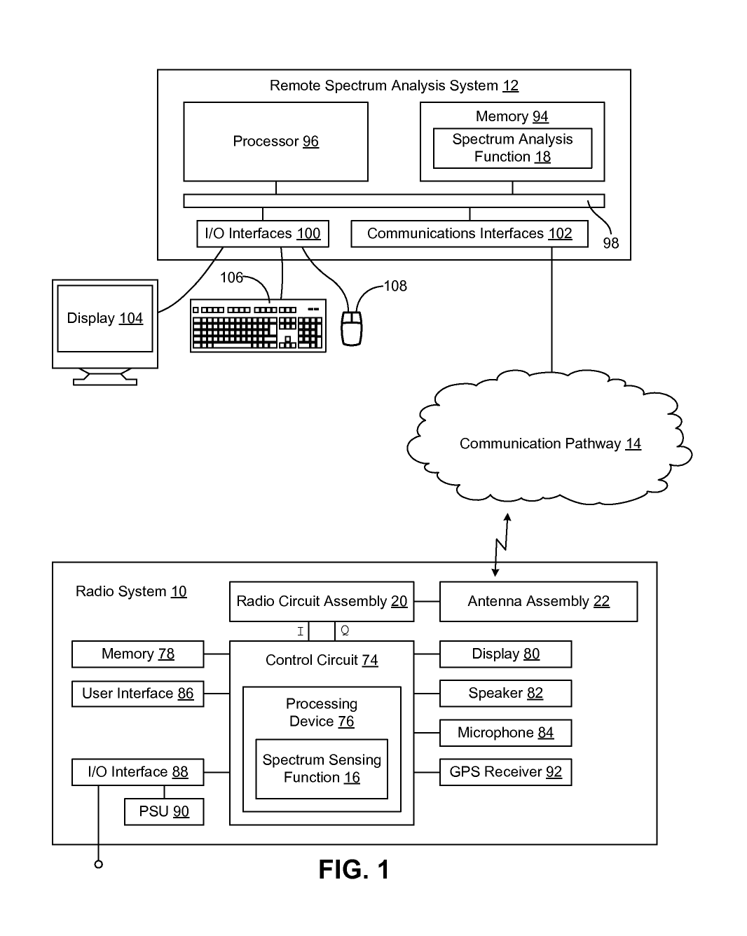

Referring initially to FIG. 1, shown is a system that includes a radio system 10 and a remote spectrum analysis system 12. The radio system 10 has wireless communication capabilities and may be configured to analyze spectrum for the presence of an incumbent user before using spectrum. Analysis also may be carried at various times during spectrum use and, if an incumbent user is detected, the radio system 10 may be configured to vacate the spectrum. The analysis may be required under appropriate government or regulatory agency regulations or may be carried out voluntarily by the radio system 10. The radio system 10 may capture a representation of the spectrum associated with an operational channel and transmit the captured representation to the remote spectrum analysis system 12. The remote spectrum analysis system 12 may, in turn, analyze the spectrum information received from the radio system 10 and return results of the analysis to the radio system 10. From the returned results, the radio system 10 may make a determination as to whether the radio system 10 may operate on the channel in the location where the representation was captured and at the current time, or potentially some other time in the future.

The remote spectrum analysis system 12 may be configured as a server device that communicates with the radio system 10 through a communication pathway 14. The communication pathway 14 may include one or more networks, and/or may involve use of the Internet. The communication pathway 14 may be available with or without use of the channel undergoing spectrum analysis. The radio system 10 may include a spectrum sensing function 16 and the analysis system 12 may include a spectrum analysis function 18. The spectrum sensing function 16 and the spectrum analysis function 18 may cooperate with each other to enable the radio system 10 to comply with government or regulatory operational requirements and/or any other interference mitigation functions of the radio system 10.

Each of the spectrum sensing function 16 and the spectrum analysis function 18 may be embodied as executable instructions (e.g., referred to in the art as code, programs, or software) that are respectively resident in and executed by the radio system 10 and the analysis system 12. The functions 16 and 18 each may be one or more programs that are stored on respective non-transitory computer readable mediums, such as one or more memory devices (e.g., an electronic memory, a magnetic memory, or an optical memory). In the following description, an ordered logical flow for the functionality of the spectrum sensing function 16 and the spectrum analysis function 18 is described. But it will be appreciated that the logical progression may be implemented in an object-oriented or a state-driven manner.

Spectrum analysis techniques are described in the document in the exemplary contexts of analyzing spectrum corresponding to white spaces and corresponding to DFS channels. The white spaces may be, but are not limited to, TV white spaces. Although these exemplary contexts are used for purposes of description, the techniques may be applied to any other frequency bands that might be used for wireless communications.

As indicated, the radio system 10 may be configured to carry out wireless communications. For this purpose, the radio system 10 may include communications circuitry in the form of a radio circuit assembly 20 and an antenna assembly 22. The radio circuit assembly 20 and the antenna assembly 22 may represent circuitry to communicate over more than one type of communication interface. Therefore, the illustrated components represent one or more than one radio transceiver, depending on the capabilities of the implementing hardware to tune to multiple frequencies and/or carry out communications using multiple protocols.

The radio circuit assembly 20 may include a front-end circuit that converts radio frequency signals for a desired operational channel into digital I and Q output signals. In one embodiment the front end circuit may include, among other circuit components, two analog to digital converters (ADCs) that respectively output the I and Q output signals. The I and Q signals may be input into a control circuit 74 that interprets the signals for the carrying out of wireless communications. During a sensing mode, the spectrum sensing function 16 may sample the I and Q signals for purposes of analyzing the corresponding spectrum for the possible presence of an incumbent user. The sampled I and Q signals may be considered the captured representation of the spectrum corresponding to the operational channel to which the radio circuit assembly 20 is tuned. Alternatively, and especially for DFS or similar channels where incumbent radar devices may be present, the representation of the spectrum may be in the form of a pulse pattern.

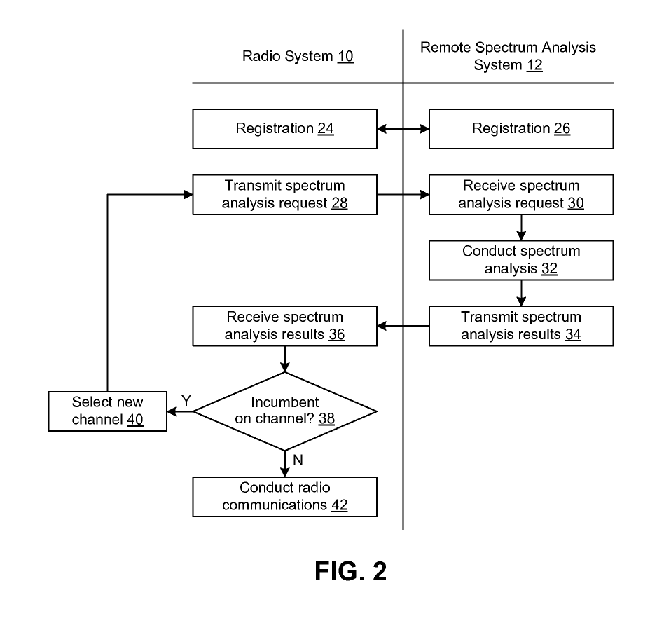

With additional reference to FIG. 2, illustrated are logical operations to implement an exemplary method of collective spectrum sensing and analysis. Portions of the illustrated exemplary method may be carried out by executing the spectrum sensing function 16 and/or the spectrum analysis function 18, for example. Thus, the flow chart of FIG. 2 may be thought of as depicting steps of a method carried out by the radio system 10 and a method carried out by the remote spectrum analysis system 12. Although FIG. 2 shows a specific order of executing functional logic blocks, the order of executing the blocks may be changed relative to the order shown. Also, two or more blocks shown in succession may be executed concurrently or with partial concurrence. Certain blocks also may be omitted.

The radio system 10 may be interested in conducting wireless communications using a channel that is defined using known spectrum characteristics such as, but not limited to, center frequency and bandwidth. The channel may be determined in an appropriate manner. For instance, for white spaces, the radio system 10 may register with a white spaces management database a receive a channel map containing the identities of potentially available channels. The radio system 10 then may select one of the potentially available channels for operation. Before using the channel and/or at times during use of the channel, the radio system 10 may be configured (and/or required) to conduct spectrum analysis to determine if the channel is clear of an incumbent user. Other channel determination techniques may be used for other types of channels, such as a DFS channel.

The logical flow may begin in blocks 24 and 26 where the radio system 10 registers with the remote spectrum analysis system 12. The registration may include transmitting radio capability information to the analysis system 12 in terms of protocols and frequencies supported by the radio system 10. Other transmitted information may include a location of the radio system 10 and any other information that may be of assistance to the remote spectrum analysis system 12 during subsequent spectrum analysis operations.

Following registration, the logical flow may proceed to block 28 where the radio system 10 transmits a spectrum analysis request to the remote spectrum analysis system 12. The spectrum analysis request may be received by the spectrum analysis system 12 in block 30. The spectrum request may be transmitted at any appropriate time, such as before commencing use of a channel selected by the radio system 10, or at regular intervals or other specified times during use of a channel. For example, spectrum analysis may be conducted according to a time interval that that is set according to a neighborhood quiet period. Other triggers to commence conducting spectrum analysis may be demand-based, such as the receipt of a prompt from the spectrum analysis system 12 for the radio system 10 to supply spectrum information for analysis. Other triggers to commence conducting spectrum analysis may include event-based triggers, such as a the detection of possible interference (e.g., detection of a predetermined signal pattern or detection of an unknown signal having a signal strength greater than a predetermined signal strength level).

The spectrum analysis request may include the location of the radio system 10 (if not already supplied or if changed from a location specified in the registration steps), a representation of the spectrum in the location of the radio system 10, an indication of the type of spectrum capture to create the representation of the spectrum (e.g., I and Q samples or pulse samples), and parameters used in the capture. These parameters, many of which are configurable, will be described in greater detail below. The radio device 10 may conduct filtering so that the spectrum information in the representation of the spectrum does not contain a representation of undesired signals (e.g., a signal below a detection threshold of the radio system 10).

As will be appreciated, in preparation for transmission of the spectrum request, the radio device 10 may collect the representation of the spectrum for the channel that the spectrum analysis system 12 will analyze. The collected information that makes up the representation may be dependent upon the type of channel to be analyzed. Spectrum capture parameters may be specified locally by the radio system 10 and/or communicated to the radio system 10 by the spectrum analysis system 12. In one embodiment where at least some of the spectrum capture parameters are established by the spectrum analysis system 12, the spectrum capture parameters may be generated using known spectrum usage and network deployment in the neighborhood of the radio system 10 (e.g., an area including and surrounding the location of the radio system 10).

Two exemplary types of information sets for the spectrum analysis request will be described, but it will be appreciated that other information or additional information may make up to the representation of the spectrum contained in the spectrum analysis request. The first example information type relates to the collection of information for data communications from a network or incumbent use of a white spaces channel, such as a selected channel from a TV white spaces channel map. In these instances, I and Q samples may be used for detecting incumbent spectrum use based on signal level. Typically, pulse pattern matching is not performed using the I and Q samples. Instead, the second example information type relates to the collection of information for the detection of radar signals or other pulse-based signals, such as may be present in DFS channels.

Spectrum capture parameters that are used in the capture of a representation of spectrum for a spectrum analysis request using I and Q samples will now be described. As mentioned, I and Q samples may be useful in analyzing spectrum corresponding to white spaces, among other types of spectrum use, where signal level is of interest.

Spectrum capture parameters for this type of spectrum capture include the duration of capture (e.g., different capture durations may be used to detect different types of incumbent user transmissions), the channels or channels for which spectrum is captured (if not previously determined or determined by default operation of the radio system 10), bandwidth (e.g., 6 MHz for a typical white spaces channel, 18 MHz for a white spaces channel and adjacent channels, or some other value such as 12 MHz or 40 MHz), resolution of the spectrum capture (e.g., the number of sample data points within the sampled bandwidth, which may be a function of sampling frequency and time), and operation of the ADC(s) in the radio circuit assembly 20 (e.g., sampling rate and bits per sample). It will be appreciated that one or more of the parameters related to ADC operation may be fixed.

The number of I and Q sample points to collect may depend on several factors. These factors may include frequency resolution, signal bandwidth and duration of capture. As the desired frequency resolution increases (e.g., becomes finer), the number of I and Q samples will increase. Also, as the bandwidth of the spectrum to be analyzed increases, the number of I and Q samples will increase. Similarly, as the duration of capture increases, the number of I and Q samples will increase.

An exemplary spectrum capture using I and Q samples now will be described. In this example, it will be assumed that the ADCs output 11 bits per sample, the bandwidth of the channel undergoing analysis is 6 MHz, and a 64 point fast Fourier transform (FFT) is used by the radio system 10. This results in a frequency resolution of about 93.75 KHz (or 6 MHz divided by 64) and an FFT period of about 10.66 microseconds (μs) (or 1/93.75 KHz). In the example, the ADC sampling rate may be set to about 6 megasamples per second. Therefore, the sample interval will be about 167 nanoseconds (ns) (or 1/6 megasamples per second). Oversampling is possible. The total sample size for the example will be about 176 bytes (or 64 times 11 bits per sample times 2 for 1 and Q samples). The spectrum capture duration may be measured in terms of the FFT periods. Therefore, the spectrum capture duration could be one FFT period, two FFT periods, five FFT periods or some other multiple (e.g., N) of the FFT period. In the example, the spectrum capture duration may be two FFT periods. In this case, the amount of spectrum data that is collected and transmitted to the spectrum analysis system 12 as part of the spectrum analysis request is about 352 bytes (or 176 bytes times 2 for the spectrum capture duration).

In sum, the data in a spectrum analysis request for signal level analysis may include, but is not limited to, I and Q samples, duration of capture, timing information, channel information, capture resolution (e.g., samples per second), capture bandwidth, and radio system 10 location.

Spectrum capture parameters that are used in the capture of a representation of spectrum for a spectrum analysis request using detected pulses will now be described. As mentioned, pulses may be useful in analyzing spectrum where a radar device may be operational. Pulse information that is collected as part of the representation of the spectrum may include pulse width (or signal pulse width), pulse timing (or signal pulse time), absolute time, and received signal strength indicator (RSSI). This information may be used to match the pulses in the representation to known radar signal pulse patterns. The signal pulse time may include information related to pulse repetition frequency (PRF) and pulses per burst (PBR). The absolute time indicates the relationship between adjacent pulse sampling. An exemplary description of how to collect this type of information is described in U.S. Pat. No. 6,954,171, although other techniques may be employed.

A data packet containing pulse information that is transmitted from the radio system 10 to the spectrum analysis system 12 may contain a number of information samples. Each sample may include, for instance, two bytes of signal pulse time information, one byte of signal pulse width information, and one byte of signal strength information. Therefore, if a data packet were to include fifty samples, the packet size may be about 200 bytes.

In sum, the data in a spectrum analysis request for pulse pattern analysis may include, but is not limited to, radio system 10 location, absolute time of start of capture, signal pulse width information (to identify a particular radar signal), signal pulse time (to identify the PRF and PBR), and signal strength information (e.g., RSSI).

With continuing reference to the figures, the spectrum analysis system 12 may conduct spectrum analysis on the representation of the spectrum that is transmitted by the radio system 10 in block 32. In one embodiment, the spectrum analysis for the radio system 10 is conducted entirely by the spectrum analysis system 12 (e.g., the radio system 10 performs no spectrum analysis). In other embodiments, some spectrum analysis functions may be carried out by the radio system 10 and other functions may be carried out by the spectrum analysis system 12. For example, the radio system 10 first may perform spectrum analysis on detected signals and, if an inconclusive result is reached as to whether an incumbent user or radar is using the spectrum of interest, then the spectrum analysis system 12 may conduct further analysis on the representation of the spectrum. The processing of the spectrum analysis system 12 may be able to detect signals with lower signal strength than detectable by the radio system 10 and/or may be able to detect radar patterns that are unknown or undecipherable to the radio system 10. Therefore, the spectrum analysis may involve a collaboration involving a portion of a detection function being run locally by the radio system 10 and a portion of a detection function being run remotely by the spectrum analysis system 12 (e.g., the radio system 10 may request the spectrum analysis system 12 to analyze the representation for certain signal patterns).

In one embodiment, the spectrum analysis system 12 analyzes only the representation of the spectrum that is received from the radio system 10. In other embodiments, the spectrum analysis system 12 may use additional information in performing the analysis. For example, the spectrum analysis system 12 may use previously acquired information about spectrum use in the network neighborhood of the radio system 10, such as the location and transmission properties of other radio systems or radar systems that are known to operate in the location of the radio system 10. The information about other deployed radio systems and radars may include, but is not limited to, location, physical (PHY) layer characteristics (e.g., time division multiple access (TDMA), etc.), transmit power, and so forth. The information regarding known radio systems, networks, radars, or other spectrum usage may be maintained in a database. The database may be stored by the spectrum analysis system 12 or by another system that is accessible by the spectrum analysis system 12. Other information that may be used by the spectrum analysis system 12 also may include detections made by other radio systems that have requested spectrum analysis.

During the course of the analysis it is possible that the spectrum analysis system 12 may determine that additional information, including but not limited to additional spectrum detections, from the radio system 10 would be of assistance to the analysis. In this case, the spectrum analysis system 12 may send a request to the radio system 10 for the desired information and the radio system 10 may reply with the requested information. The requested information may be, for example, a new spectrum representation that has been captured with a different set of capture parameters than previously used.

The results of the analysis may be in the form of a positive determination that an incumbent spectrum user (radio system or radar) is present or a negative determination that an incumbent spectrum user is not present. Other formats for the results are possible. For example, in the case of measuring signal strength, the result may be a quantification of the detected signal level, if any. Other results may include information about known spectrum use in the neighborhood of the radio system 10, such as known spectrum use of adjacent channels to the analyzed channel or known spectrum use for the analyzed channel in locations that are nearby the present location of the radio system 10. In one embodiment, the radio system 10 may detect a radar pattern and this detection may be used as a trigger to request additional spectrum analysis from the spectrum analysis system 12. But if the spectrum analysis system 12 determines that the detected pattern is actually the result of network traffic in the location of the radio system 10, then the spectrum analysis system 12 may inform the radio system 10 that the trigger was a false trigger.

In yet another embodiment, the radio system 10, as part of the spectrum request, may set a spectrum analysis results preference for the type of information to be returned in the analysis results. For instance, the radio system 10 may indicate that the analysis results should be in the form of any co-channel spectrum use, the nature of the use (e.g., television broadcast, network usage by another radio system, etc.), and/or transmission information (e.g., signal strength, number of co-channel users, etc.).

With continuing reference to the figures, in block 34 the spectrum analysis system 12 may transmit the analysis results to the radio system 10. The results may be received by the radio system 10 in block 36.

Next, in block 38, the radio system 38 may make a determination as to whether an incumbent user is present on the channel so as to preclude use of the channel or make use of the channel undesirable. If a positive determination is made in block 38, the logical flow may proceed to block 40 where the radio system 40 may select a different channel for analysis. Following block 40, the logical flow may return to block 28. If a negative determination is made in block 38, the logical flow may proceed to block 42 where the radio system 10 may engage in radio communications using the channel that was the subject of the analysis.

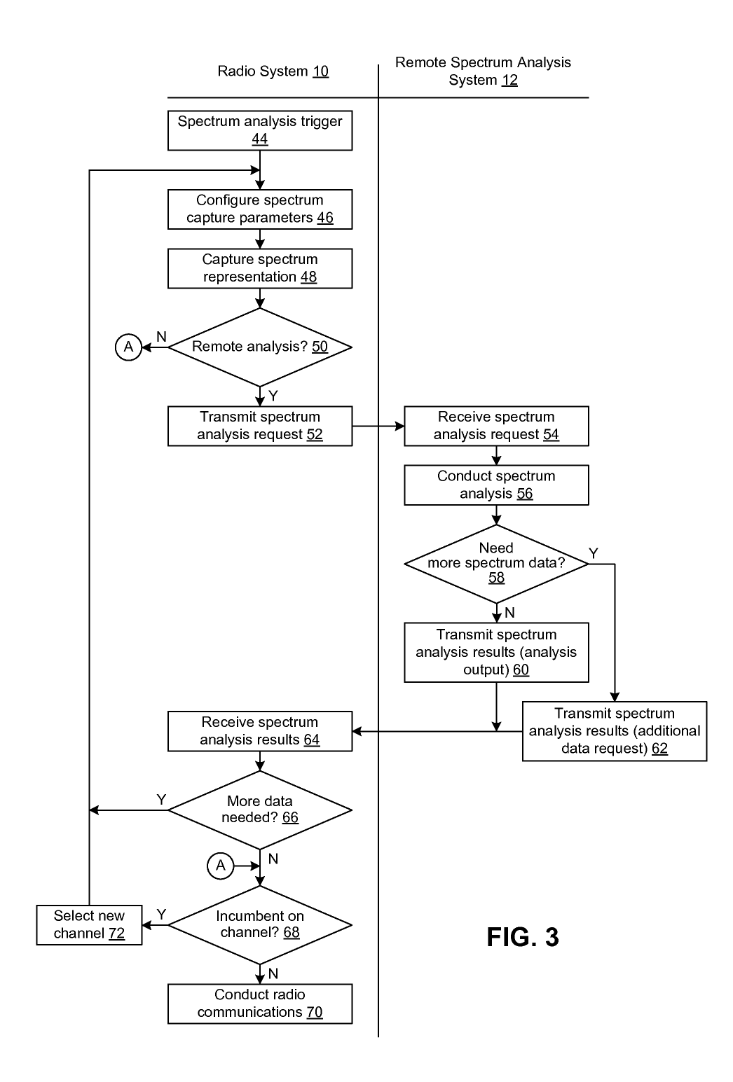

With additional reference to FIG. 3, illustrated are logical operations to implement another exemplary method of conducting spectrum analysis for the detection of an incumbent user. The exemplary method may be carried out by executing the spectrum sensing function 16 and/or the spectrum analysis function 18, for example. Thus, the flow chart of FIG. 3 may be thought of as depicting steps of a method carried out by the radio system 10 and a method carried out by the spectrum analysis system 12. Although FIG. 3 shows a specific order of executing functional logic blocks, the order of executing the blocks may be changed relative to the order shown. Also, two or more blocks shown in succession may be executed concurrently or with partial concurrence. Certain blocks also may be omitted. In addition, some of the operations illustrated and described with respect to FIG. 3 may be supplemented and/or replaced by operations illustrated and described with respect to FIG. 2. Therefore, aspects from the two logical flows may be combined to form alternative approaches to spectrum analysis.

The logical flow may begin in block 44 where a spectrum analysis trigger occurs. Various spectrum analysis triggers have been discuss above and, for the sake of brevity, will not be discussed again. It will be noted, however, that the spectrum analysis trigger may arise locally at the radio system 10 or may be invoked by receipt of a triggering communication from the spectrum analysis system 12. Also, it may be assumed that prior to block 44, the radio system 10 has been registered with the spectrum analysis system 12.

Next, in block 46, the radio system 10 may configure itself with spectrum capture parameters in preparation for capturing an appropriate representation of the spectrum to be analyzed. As indicated, the spectrum capture parameters may be predetermined, established by the radio device 10, and/or communicated to the radio device 10 from the spectrum analysis system 12.

In block 48, the radio device 10 may capture the representation of the spectrum. Spectrum representation capture techniques are described above and, for the sake of brevity, will not be repeated.

In block 50, a determination may be made as to whether remote analysis of the representation of the spectrum should be carried out by the spectrum analysis system 12. If a positive determination is made in block 50, the logical flow may proceed to block 52 where a spectrum analysis request, as described in detail above, is transmitted to the spectrum analysis system 12. The spectrum analysis request may be received by the spectrum analysis system 12 in block 54.

Following receipt of the spectrum analysis request, the spectrum analysis system 12 may analyze the representation of the spectrum in block 56. Analysis of the representation of the spectrum to detect presence of an incumbent user is described above and, for the sake of brevity, will not be repeated. As part of the analysis, a determination may be made in block 58 as to whether the spectrum analysis will be assisted by the acquisition of additional spectrum data (e.g., one or more additional representations of spectrum, or samples). If a negative determination is made in block 58, the logical flow may proceed to block 60 where a spectrum analysis result is transmitted to the radio system 10. The analysis result that is transmitted in block 60 may contain a substantive output of the analysis that is indicative of the presence or absence of an incumbent user as described in greater detail with respect to block 34. If a positive determination is made in block 58, the logical flow may proceed to block 62 where a spectrum analysis result in the form a request for additional spectrum data is transmitted to the radio system 10. The spectrum analysis result of block 62 may include additional or changed spectrum capture parameters for the radio device 10.

The spectrum analysis result of the appropriate one of block 60 or block 62 is received by the radio system 10 in block 64. A determination may be made in block 66 as to whether the spectrum analysis result indicates that additional spectrum data is needed. If a positive determination is made in block 66, the logical flow may return to block 46.

If a negative determination is made in block 66, or following a negative determination in block 50, the logical flow may proceed to block 68. In block 68, a determination may be made as to whether an incumbent user is present on the channel undergoing analysis. If a negative determination is made in block 68, the logical flow may proceed to block 70 and the radio system 10 may initiate or continue radio communications using the channel of interest. If a positive determination is made in block 68, the logical flow may proceed to block 72 where a different channel may be selected. In one embodiment, following block 72 the spectrum analysis routine may be repeated for the newly selected channel.

The described spectrum analysis techniques may minimize false positive detections of incumbent spectrum users or radar patterns. For example, sophisticated and processor intensive software implementations in the spectrum analysis system 12 may be used to efficiently and accurately determine if a triggering event is due to the presence of an incumbent spectrum user or an actual radar signal. This type of software may be too computationally intensive to implement in the radio system 10. Additionally, the described spectrum analysis techniques may be easier to implement in a forward compatible manner. That is, software updates and new radar signal patterns may be implemented in the spectrum analysis system 12, but not in each radio system that uses the spectrum analysis system 12 for spectrum analysis. Also, “off-line” analysis may be carried out by collecting spectrum information and transferring the collected information to the spectrum analysis system 12 for analysis at a later point in time. For example, a field technician may use a radio system and a portable computer to collect spectrum information at a site of interest and then make use of the spectrum analysis system 12 to analyze the captured information at a convenient time, which may be hours or days after the collection of the spectrum information.

Returning to FIG. 1, overall functionality of the radio system 10 may be controlled by a primary control circuit 74 that includes a processing device 76. Data stored by the radio system 10 may be stored in a memory 78. The processing device 76 may execute code stored in a memory (not shown) within the control circuit 74 and/or in a separate memory (e.g., the memory 78) in order to carry out operation of the radio device 10. For instance, the processing device 76 may be used to execute the spectrum sensing function 16. The memory 78 may be, for example, one or more of a buffer, a flash memory, a hard drive, a removable media, a volatile memory, a non-volatile memory, a random access memory (RAM), or other suitable device. In a typical arrangement, the memory 78 may include a non-volatile memory for long term data storage and a volatile memory that functions as system memory for the control circuit 74. The memory 78 may exchange data with the control circuit 74 over a data bus. Accompanying control lines and an address bus between the memory 78 and the control circuit 74 also may be present.

Another component of the radio system 10 may be a display 80 that is used to display visual information to a user. The radio system 10 may include a speaker 82 and a microphone 84 to allow the user to carry out voice conversations and perform other audio functions. A user interface 86, such as a keypad and/or touch screen associated with the display 80, may be present to provide for a variety of user input operations.

The radio system 10 may further include one or more input/output (I/O) interface(s) 88. The I/O interface(s) 88 may include one or more electrical connectors for connecting the radio system 10 to another device (e.g., a computer) or an accessory (e.g., a personal handsfree (PHF) device) via a cable, and/or for connecting the radio system 10 to a power supply. Therefore, operating power may be received over the I/O interface(s) 88 and power to charge a battery of a power supply unit (PSU) 90 within the radio system 10 may be received over the I/O interface(s) 88. The PSU 90 may supply power to operate the radio system 10 in the absence of an external power source.

The radio system 10 also may include various other components. For instance, a position data receiver, such as a global positioning system (GPS) receiver 92, may be involved in determining the location of the radio system 10.

Turning now to the spectrum analysis system 12, the spectrum analysis system 12 may be implemented as a computer-based system that is capable of executing computer applications (e.g., software programs), including the spectrum analysis function 18. The spectrum analysis function 18, and any affiliated database information, may be stored on a computer readable medium, such as a memory 94. The memory 94 may be a magnetic, optical or electronic storage device (e.g., hard disk, optical disk, flash memory, etc.), and may comprise several devices, including volatile and non-volatile memory components. Accordingly, the memory 94 may include, for example, random access memory (RAM) for acting as system memory, read-only memory (ROM), hard disks, optical disks (e.g., CDs and DVDs), tapes, flash devices and/or other memory components, plus associated drives, players and/or readers for the memory devices.

To execute the spectrum analysis function 18, the spectrum analysis system 12 may include one or more processors 96 used to execute instructions that carry out corresponding logic routine(s). The processor 96 and the components of the memory 94 may be coupled using a local interface 98. The local interface 98 may be, for example, a data bus with accompanying control bus, a network, or other subsystem.

The spectrum analysis system 12 may have various video and input/output (I/O) interfaces 100 as well as one or more communications interfaces 102. The interfaces 100 may be used to operatively couple the spectrum analysis system 12 to various peripherals, such as a display 104, a keyboard 106, a mouse 108, an external memory (not shown), etc. The communications interface 102 may include for example, a modem and/or a network interface card. The communications interface 102 may enable the spectrum analysis system 12 to send and receive data signals, voice signals, video signals, and the like to and from other computing devices and the radio system 10. In particular, the communications interface 102 may connect the spectrum analysis system 12 to the communication pathway 14.

Although certain embodiments have been shown and described, it is understood that equivalents and modifications falling within the scope of the appended claims will occur to others who are skilled in the art upon the reading and understanding of this specification.

What is claimed is:

1. A radio system that identifies incumbent use of a wireless communication channel, comprising:
a radio circuit assembly; and
a control circuit configured to:
control the radio circuit to collect a representation of spectrum for the channel;
output the representation of the spectrum to a remotely located spectrum analysis system that is configured to analyze the representation of the spectrum for presence of an incumbent user; and
determine from a reply from the spectrum analysis system that indicates presence or absence of the incumbent user on the channel whether the channel is available for use by the radio system to conduct wireless communications.

2. The radio system of claim 1, wherein the representation of the spectrum includes I and Q samples.

3. The radio system of claim 2, wherein the radio system also outputs spectrum capture parameters that were used during collection of the I and Q samples for the representation of the spectrum to the spectrum analysis system.

4. The radio system of claim 3, wherein the spectrum capture parameters include one or more of duration of capture, timing information, channel information, capture resolution, capture bandwidth, or radio system location.

5. The radio system of claim 2, wherein the analysis by the spectrum analysis system includes ascertaining signal level of spectrum use by the incumbent user.

6. The radio system of claim 5, wherein the analysis by the spectrum analysis system includes ascertaining signal levels as low as −114 dBm.

7. The radio system of claim 1, wherein the representation of the spectrum includes pulse signal information.

8. The radio system of claim 7, wherein the pulse signal information includes pulse time information, pulse width information, and signal strength information.

9. The radio system of claim 7, wherein the radio system also outputs radio system location during collection of the pulse signal information for the representation of the spectrum to the spectrum analysis system.

10. The radio system of claim 7, wherein the analysis by the spectrum analysis system includes matching pulse signal information to a known radar signal pattern from a plurality of known radar signal patterns.

11. The radio system of claim 1, wherein detection of a radar signal pattern with the radio system triggers the collection and output of the representation of the spectrum for confirmation by the spectrum analysis system that a radar system is operating in a location of the radio system.

12. The radio system of claim 1, wherein the collection and output are triggered by receipt of a request from the spectrum analysis system.

13. The radio system of claim 12, wherein spectrum capture parameters that are used during the collection are specified by the spectrum analysis system.

14. A method of identifying incumbent use of a wireless communication channel, comprising:
collecting a representation of spectrum for the channel with a radio system;
transmitting the representation of the spectrum to a remotely located spectrum analysis system that is configured to analyze the representation of the spectrum for presence of an incumbent user;
receiving a reply from the spectrum analysis system that indicates presence or absence of the incumbent user on the channel; and
determining from the reply whether the channel is available for use by the radio system to conduct wireless communications.

15. The method of claim 14, wherein the representation of the spectrum includes I and Q samples.

16. The method of claim 15, wherein the radio system also transmits spectrum capture parameters that were used during collection of the I and Q samples for the representation of the spectrum to the spectrum analysis system, wherein the spectrum capture parameters include one or more of duration of capture, timing information, channel information, capture resolution, capture bandwidth, or radio system location.

17. The method of claim 15, wherein the analysis by the spectrum analysis system includes ascertaining signal level of spectrum use by the incumbent user.

18. The method of claim 17, wherein the analysis by the spectrum analysis system includes ascertaining signal levels as low as −114 dBm.

19. The method of claim 14, wherein the representation of the spectrum includes pulse signal information, including pulse time information, pulse width information, and signal strength information.

20. The method of claim 19, wherein the radio system also transmits radio system location during collection of the pulse signal information for the representation of the spectrum to the spectrum analysis system.

21. The method of claim 19, wherein the analysis by the spectrum analysis system includes matching pulse signal information to a known radar signal pattern from a plurality of known radar signal patterns.

22. The method of claim 14, wherein detection of a radar signal pattern with the radio system triggers the collection and output of the representation of the spectrum for confirmation by the spectrum analysis system that a radar system is operating in a location of the radio system.

23. A method of spectrum analysis to identify incumbent use of a wireless communication channel for a remotely located radio system, comprising:
receiving a representation of spectrum for the channel from the radio system;
analyzing the representation of the spectrum for presence of an incumbent user; and
transmitting a reply to the radio system that indicates presence or absence of the incumbent user on the channel.

24. The method of claim 23, wherein the representation of the spectrum includes I and Q samples.

25. The method of claim 24, wherein the receiving also includes receiving spectrum capture parameters that were used during collection of the I and Q samples for the representation of the spectrum.

26. The method of claim 26, wherein the spectrum capture parameters include one or more of duration of capture, timing information, channel information, capture resolution, capture bandwidth, or radio system location.

27. The method of claim 24, wherein the analyzing includes ascertaining signal level of spectrum use by the incumbent user.

28. The method of claim 27, wherein the analyzing includes ascertaining signal levels as low as −114 dBm.

29. The method of claim 23, wherein the representation of the spectrum includes pulse signal information.

30. The method of claim 29, wherein the pulse signal information includes pulse time information, pulse width information, and signal strength information.

31. The method of claim 29, wherein the receiving also includes receiving radio system location during collection of the pulse signal information for the representation of the spectrum.

32. The method of claim 29, wherein the analyzing includes matching pulse signal information to a known radar signal pattern from a plurality of known radar signal patterns.

33. The method of claim 23, wherein detection of a radar signal pattern with the radio system triggers the radio system to transmit the representation of the spectrum for carrying out of the analyzing to confirm that a radar system is operating in a location of the radio system.

34. The method of claim 23, further comprising transmitting a request to the radio system to trigger the radio system to transmit the representation of the spectrum.

35. The method of claim 34, wherein the request includes spectrum capture parameters that are used by the radio system for collection of spectrum information for the representation of the spectrum.

36. The method of claim 23, wherein the analyzing includes using information regarding known operation of incumbent users to generate the reply.
